(19) United States
(12) Patent Application Publication
(10) Pub. No.: US 2005/0052550 A1
(43) Pub. Date: Mar. 10, 2005

(54) Image-file managing system and optical apparatus for observing object

(75) Inventor: Koichi Sato, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/933,386

(22) Filed: Sep. 3, 2004

(30) Foreign Application Priority Data
Sep. 4, 2003 (JP) P2003-312110
Sep. 4, 2003 (JP) P2003-312130
Sep. 4, 2003 (JP) P2003-312176

(51) Int. Cl. H04N 5/76

(52) U.S. Cl. 348/231.2

(57) ABSTRACT

According to the present invention, an image-file managing system is provided. The present image-file managing system comprises a recording medium and a file-binding system. The recording medium stores illustrated-guide data. Further, the file-binding system binds an object-image file of an observation target and the illustrated-guide data.

### BACKGROUND OF THE INVENTION

1. Field of the Invention

The present invention relates to an image-file managing system and an optical apparatus for observing an object which is provided with an image indicating device or an image-capturing device.

2. Description of the Related Art

A digital binoculars is known as an example of an optical apparatus that is provided with a digital camera. The digital binoculars which can display and store images substantially the same as the images viewed through the binoculars is disclosed in Japanese unexamined patent publication (KOKAI) No. 2003-107369.

### SUMMARY OF THE INVENTION

An object of the present invention is to provide a file-managing system and an optical apparatus (including digital camera) that can simply and swiftly bind an image to illustrated-guide data. Another aspect of the present invention is to provide an optical apparatus that is able to display information that relates to an object.

According to the present invention, an image-file managing system is provided that comprises a recording medium and a file-binding system.

The recording medium stores illustrated-guide data. The file-binding system binds an object-image file of an observation target and the illustrated-guide data.

Further, a digital camera and an optical apparatus that comprise an imaging device, a recording medium, and a file-binding system is provided. The imaging device is for capturing an object-image of an observation object.

Further more, an optical apparatus for observing an object is provided that comprises an image-indicating device, a recording medium, and control buttons.

The recording medium comprises a hierarchal folder system where the observation target is classified in categories based on predetermined attributes. The categories are hierarchally combined as folders. Illustration-image files of illustrated-guide data, which comprises image data relating to the observation target, are allocated in the lowest subfolders of the hierarchal folder system. Further, the recording medium comprises, folder-image files that comprise image data representing the respective folders. The control buttons are used to select and designate a current folder along the structure of the hierarchal folder system. An image of a folder-image file corresponding to the current folder is displayed on the image-indicating device, and images of the illustration-image files are displayed on the image-indicating device when the current folder is at the lowest subfolder level.

### BRIEF DESCRIPTION OF THE DRAWINGS

The objects and advantages of the present invention will be better understood from the following description, with reference to the accompanying drawings in which:

FIG. 1 is a perspective view of electronic binoculars in the first embodiment, viewed from the objective lens side;

FIG. 2 is a block diagram showing the electric construction of the digital binoculars depicted in FIG. 1;

FIG. 3 depicts an example of a hierarchical structure of folders (directories) in the recording medium M;

FIG. 4 is an example of files stored in the folder “\ILLUSTRATED BIRD GUIDE\AUTUMN\TOWN\SMALL;

FIG. 5 illustrates examples of the files “thrush.jpg” and “the “thrush.jpeg”;

FIG. 6 is an example of image files (folder-images) which are stored in the folder “ILLUSTRATED BIRD GUIDE”;

FIG. 7 illustrates representatives of each of the “title.bmp” (ILLUSTRATED BIRD GUIDE), “season3.bmp” (AUTUMN), “area3.bmp” (TOWN), and “size3.bmp” (SMALL);

FIGS. 8A to 8C are flowcharts of the illustration-image indicating operation (the illustrated-guide mode) of the first embodiment;

FIG. 9 schematically illustrates the structure of the object-image file that includes a header area Ah and an image data storing area Ad;

FIGS. 10A and 10B are a flowcharts of the illustration-image indicating operation (the illustrated-guide mode) of the second embodiment;

FIG. 11 schematically illustrates a multi-image indication;

FIG. 12 illustrates an example of the hierarchical structure of folders (directories) in the recording medium M;

FIG. 13 illustrates an example of the bitmap images stored in the folders “GUIDE01” and “GUIDE02”; and

FIGS. 14A to 14C are a flowchart of the illustration-image indicating operation (the illustrated-guide mode) of the third embodiment.

### DESCRIPTION OF THE PREFERRED EMBODIMENTS

The present invention is described below with reference to the embodiments shown in the drawings.

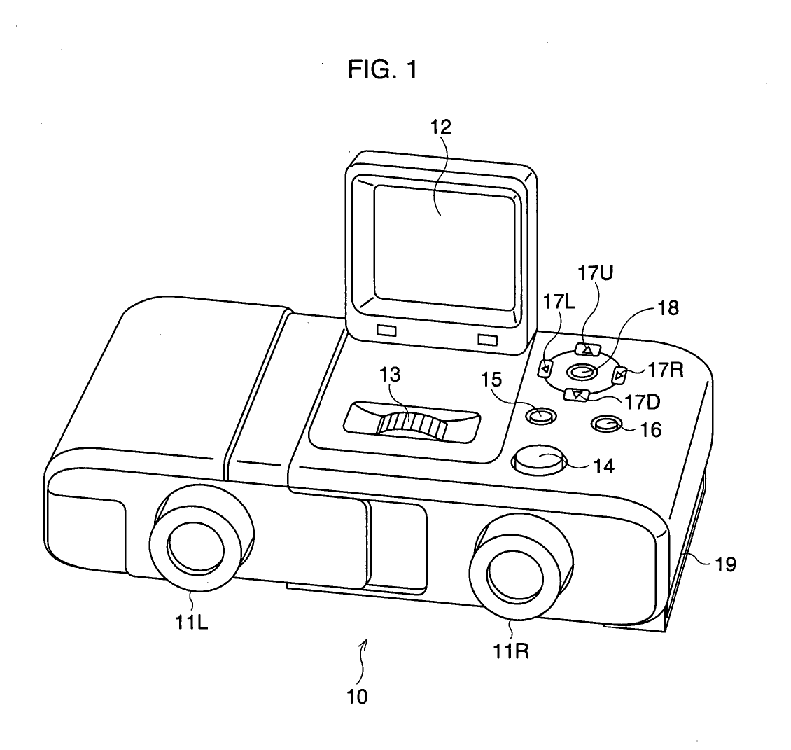

FIG. 1 is a perspective view of a digital binoculars (digital camera provided binoculars) of a first embodiment, which is viewed from the ocular lens side (backside).

A pair of ocular units 11R and 11L is provided on the backside of the digital binoculars 10, and an image-indicating device 12, such as an LCD, is provided on top of the digital binoculars 10. In this example, the image-indicating device 12 is disposed about the center of the top surface. In front of the image-indicating device 12, at the side closer to the ocular units 11R and 11L than the image-indicating device 12, a focusing drive ring 13 for a focusing operation is arranged. The image-indicating device 12 is formed as a folding type panel and is rotatably fixed to the binoculars, along an axis parallel to the ridgeline formed by the top face and the front face. Namely, when the image-indicating device 12 is opened, the image-indicating device 12 is substantially erected with its screen facing the backside. Further, when the image-indicating device 12 is closed or folded, the image-indicating device 12 is laid down upon the top face of the casing. Note that, a focusing operation of an optical system for image capturing (not depicted) is associated with a focusing operation of the optical systems of the binoculars, including the ocular units 11L and 11R, and carried out by operating the focusing drive ring 13.

As shown in FIG. 1, a release button 14 is provided on the right-hand side of the top face of the digital binoculars 10. On the front side of the release button 14, a menu button 15, a display button 16, four cursor keys 17U, 17D, 17R, and 17L, which correspond to respective up, down, right, and left directions, and an OK button 18, surrounded by the four cursor keys, are provided. Further, on a side of the digital binoculars 10, a card slot 19 into which a recording medium, such as an IC memory card, a magnetic disk, an optical disk, and the like, is inserted is formed.

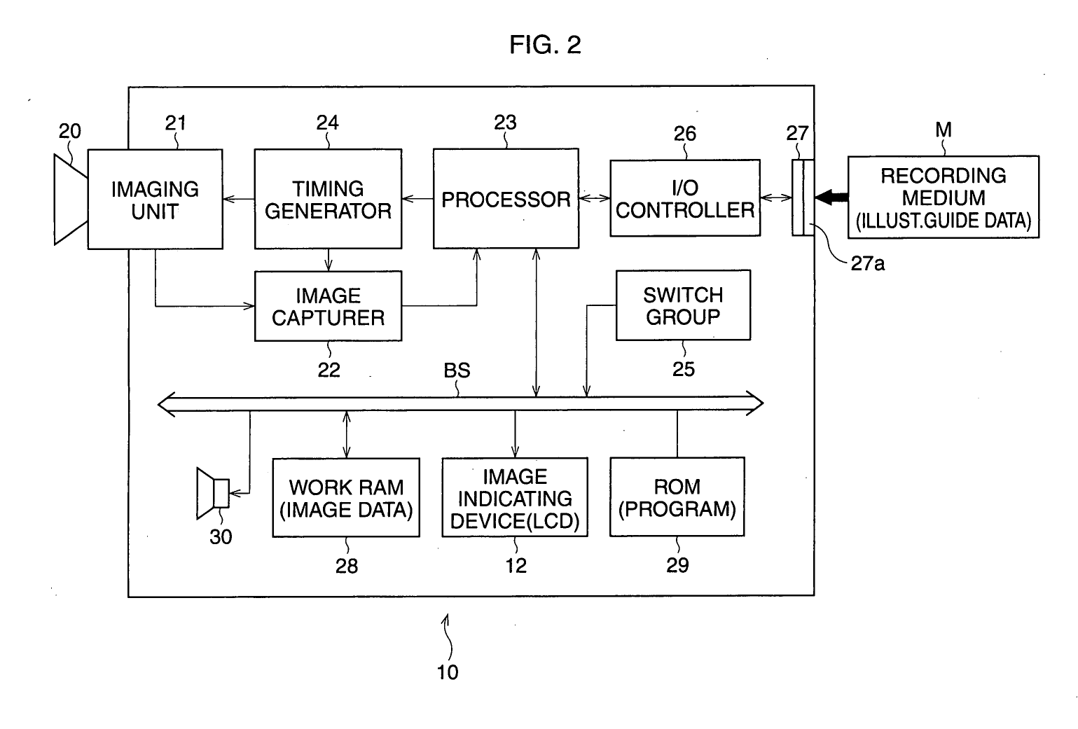

FIG. 2 is a block diagram showing the electric construction of the digital binoculars 10 depicted in FIG. 1.

Light made incident into a photographing optical system 20 produces an object image on an imaging device, such as a CCD, inside an imaging unit 21 and is converted into image signals. In the imaging unit 21, predetermined signal processes, relating to the imaging device, are carried out. The image signals are then fed to a processor 23 through an image capturer 22.

The image capturer 22 is a circuit that temporally stores image signals (image data) from the imaging unit 21 in accordance with an operation of the release button 14. For example, images currently being captured by the imaging device can be displayed on the image-indicating device 12 as live video. In this case, the image capturer 22 successively outputs resolution reduced image signals, of which the number of pixels is thinned out, to the processor 23. The image signals are then successively fed to the image-indicating device 12 via a bus BS and displayed on a screen of the image-indicating device 12 as live video. When the release button 14 is operated, the current image is temporally stored in a memory (not depicted), for example, without thinning out the data.

The image data stored in the image capturer 22 may be displayed on the image-indicating device 12 as a still image, through the processor 23 and the bus BS. Note that, the imaging unit 21 and the image capturer 22 are controlled based on synchronizing signals form a timing generator 24. The timing generator 24 is controlled by the processor 23. Further, a switch group 25, including control buttons such as the release button 14, the menu button 15, the display button 16, the cursor keys 17U, 17D, 17R, 17L, as well as the OK button 18, and a speaker 30 are connected to the processor 23, for example, via the bus BS.

Note that, in the present embodiment, a plurality of control buttons, such as the cursor keys 17U, 17D, 17R, 17L, the OK button 18, and so on, are provided for setting, selecting, or designating modes, folders, files, and so on. However, any other type of input device(s), a single manually operated member or a plurality of manual operated members, can be used in place of the above-described buttons. For example, the control buttons can be replaced by a single manually operated member which functions in the same way as the cursor keys when it is inclined toward different directions and functions as an OK button when it is depressed.

Further, an I/O controller 26 is connected to the processor 23, and a recording medium controller 27 is connected to the I/O controller 26. The recording medium controller 27 may be provided with a recording medium connecter 27a, for detachably connecting a recording medium M, including an IC memory card, so that the memory capacity, structure of the hierarchical file system, and currently available free storage of the recording medium M is detected. Further, data read/write operations are carried out through the recording medium controller 27. For example, the image data, which is obtained by the image capturing operation and temporally stored in the image capturer 22, is stored in the free storage (available space) of the recording medium M via the processor 23, the I/O controller 26, and the recording medium controller 27. Further, the image data stored in the recording medium M can be transmitted to a work RAM 28 via the recording medium controller 27, the I/O controller 26, the processor 23, and the bus BS. Note that, the processor 23 is driven in accordance with a system program stored in the ROM 29.

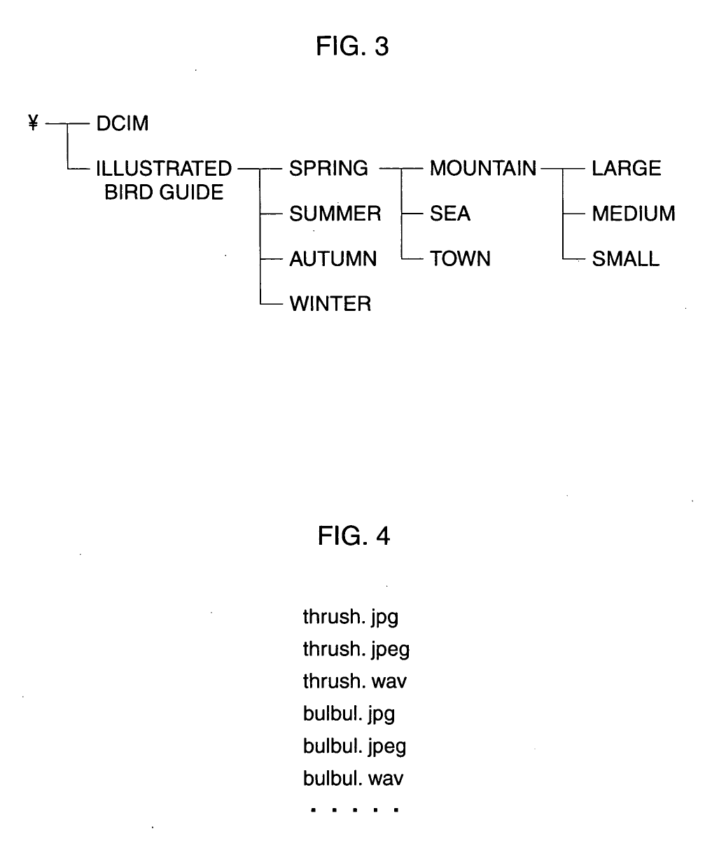

With reference to FIGS. 3 to 9, an illustration-image indicating operation (an illustrated-guide mode) which is carried out by the processor 23 in the first embodiment will be explained. In this embodiment, bird watching with the digital binoculars 10 is used as an example.

FIG. 3 depicts an example of a hierarchical structure of folders (directories) in the recording medium M. As shown in FIG. 3, at the root (root directory) of the recording medium M, for example, folders “DCIM” and “ILLUSTRATED BIRD GUIDE” exist. The folder “DCIM” is a folder for storing still-image files (object images) of image data obtained by the digital camera of the digital binoculars 10. Namely, while the processor 23 is carrying out the typical image capturing processes for a normal digital camera (i.e., before performing the illustration-image indicating operation), the current folder (current directory) is at a certain subfolder-under the “DCIM” folder. A captured still-image (object image) is stored in the free storage of the recording medium M (e.g., as JPEG image), as a file in the predetermined subfolder of the “DCIM” folder.

For example, four folders “SPRING”, “SUMMER”, “AUTUMN”, and “WINTER”, which correspond to the four seasons, exist under the “ILLUSTRATED BIRD GUIDE” folder. Under each of four folders, folders corresponding to the observation scenes (e.g. habitats) exist, for example, “MOUNTAIN”, “SEA”, “TOWN”. Further, folders corresponding to the size of the bird, such as the “LARGE”, “MEDIUM”, and “SMALL” exist under each of the folders “MOUNTAIN”, “SEA”, and “TOWN”. Note that, in FIG. 3, only the folders “MOUNTAIN”, “SEA”, and “TOWN” of the “SPRING” and only the folders “LARGE”, “MEDIUM”, and “SMALL” of the “MOUNTAIN” are illustrated, and the other subfolders are neglected for convenience.

Image files of birds (illustration images) that are classified in accordance with the above seasons, scenes, and sizes, and files including information relating to these illustration image files are stored in each of “LARGE”, “MEDIUM”, and “SMALL” folders, which exist under the respective seasons, scenes, and sizes. In FIG. 4, files stored in the folder “\ILLUSTRATED BIRD GUIDE\AUTUMN\TOWN\SMALL” are listed as an example. For example, the file “thrush.jpg” is an illustration image file of a thrush, and the file “thrush.jpeg” is an illustration image file with character information (including marks, symbols, and the like), such as the name of a bird and the like. Namely, “thrush.jpeg” is composition of the “thrush.jpg” and the image information. Further, “thrush.wav” is voice data of the thrush.

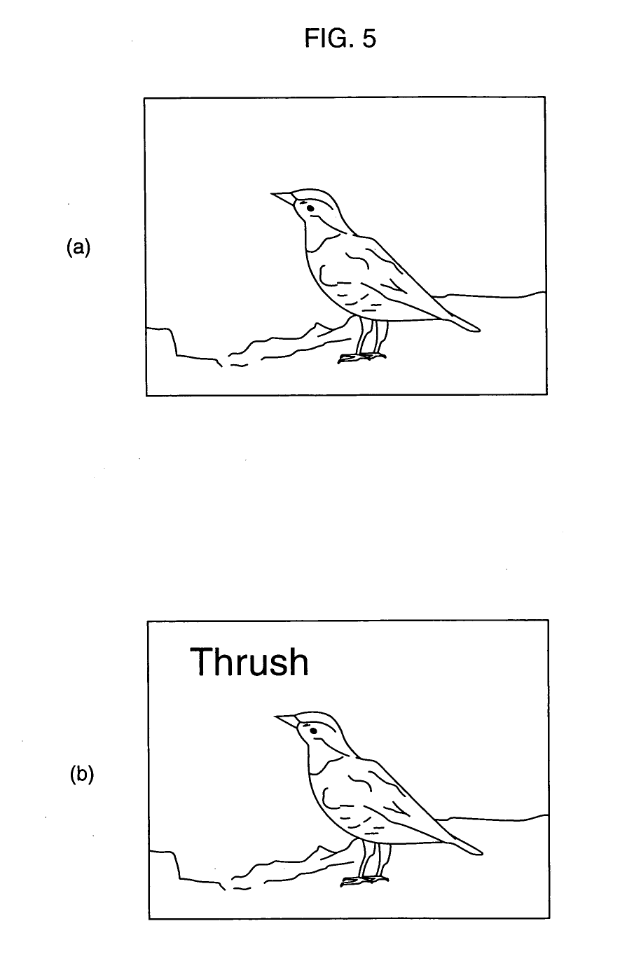

FIG. 5 represents examples of the files “thrush.jpg” and the “thrush.jpeg”. The “thrush.jpg” is illustrated at (a) and the “thrush.jpeg” is illustrated at (b). Note that, although only the files relating to the thrush and the bulbul are listed in FIG. 4, many other image files and corresponding voice files relating to various small birds that can be found in towns during autumn can be stored in the folder “\ILLUSTRATED BIRD GUIDE\AUTUMN\TOWN\SMALL”. Further, a file that relates to birds which can be seen during all seasons or in a plurality of places, e.g. both towns and mountains, is stored in all folders that meet the conditions.

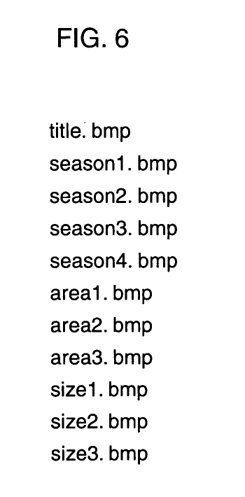

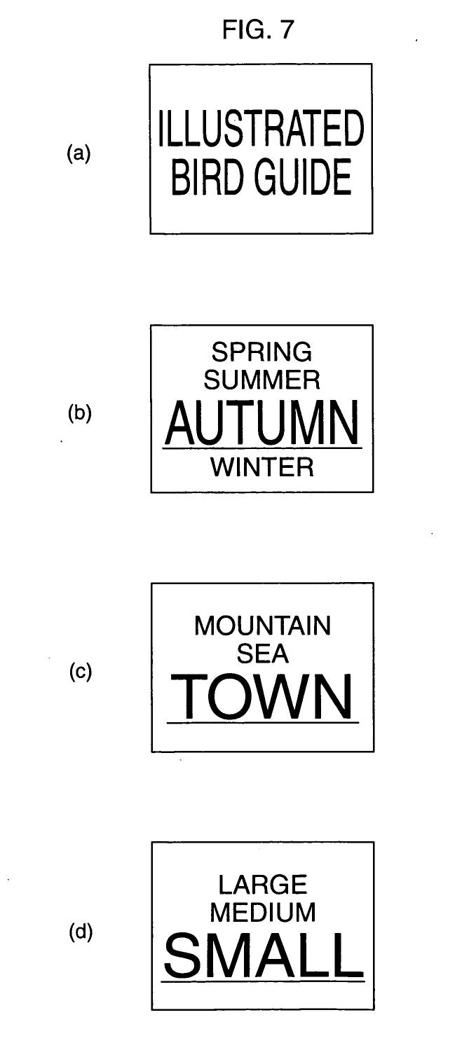

On the other hand, image files (folder-images), such as bitmap data as listed in FIG. 6, are stored in the folder “ILLUSTRATED BIRD GUIDE”. The folder-image files “area1.bmp”, “area2.bmp”, and “area3.bmp” correspond to the respective folders “MOUNTAIN”, “SEA”, and “TOWN” and the folder-image files “season1.bmp”, “season2.bmp”, “season3.bmp”, and “season4.bmp” correspond to the respective folders “SPRING”, “SUMMER”, “AUTUMN”, and “WINTER”. Further, the folder-image files “size1.bmp”, “size2.bmp”, and “size3.bmp” correspond to the respective folders “LARGE”, “MEDIUM”, and “SMALL” and the folder-image file “title.bmp” corresponds to the folder “ILLUSTRATED BIRD GUIDE”. The representative of each of the “title.bmp” (ILLUSTRATED BIRD GUIDE), “season3.bmp” (AUTUMN), “area3.bmp” (TOWN), and “size3.bmp” (SMALL) is shown at (a)-(d) of FIG. 7. Note that, the size of the bitmap files (BMP files) stored in the above “ILLUSTRATED BIRD GUIDE” folder and the JPEG image files of the birds is substantially small compared to still images (object image) that are obtained by the imaging device, since resolution of the above folder-images and illustration-images is merely required to satisfy the resolution of the image-indicating device 12. Therefore, the free storage or the available space for storing object-images can be secured in the recording medium M.

As described above, in the first embodiment, an illustration-image file with the “jpeg” extension (a composite image of a bird image and the character information) is provided in addition to a plain illustration-image file of a bird with the “jpg” extension. The images of files that have the same base file name (such as “thrush” and so on) but different extensions, “jpg” and “jpeg”, can be alternately displayed according to an operation of a user, so that superimposition of the character information onto the illustration image of a bird can be simply emulated. Thereby, both character information and an illustration image can be easily viewed and recognized.

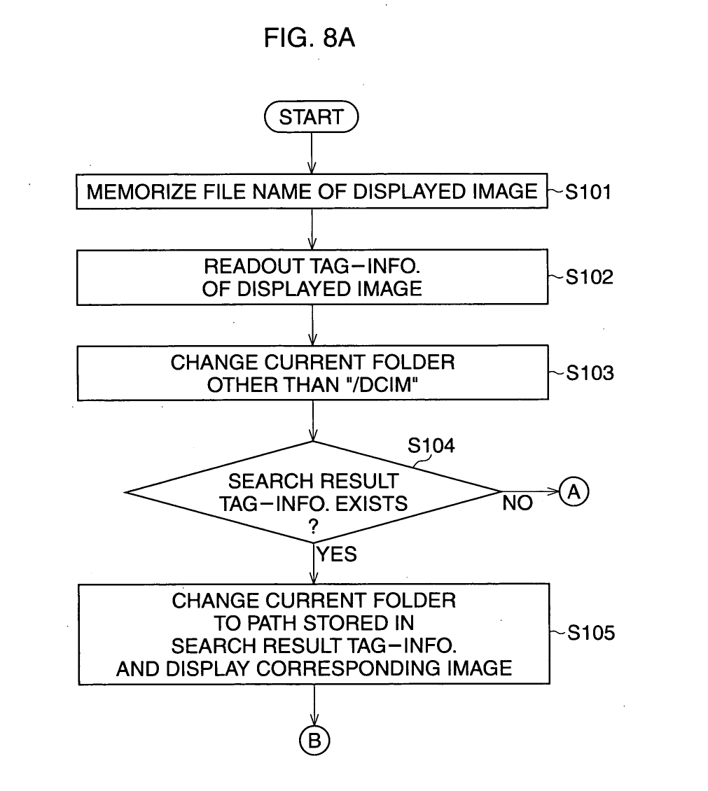

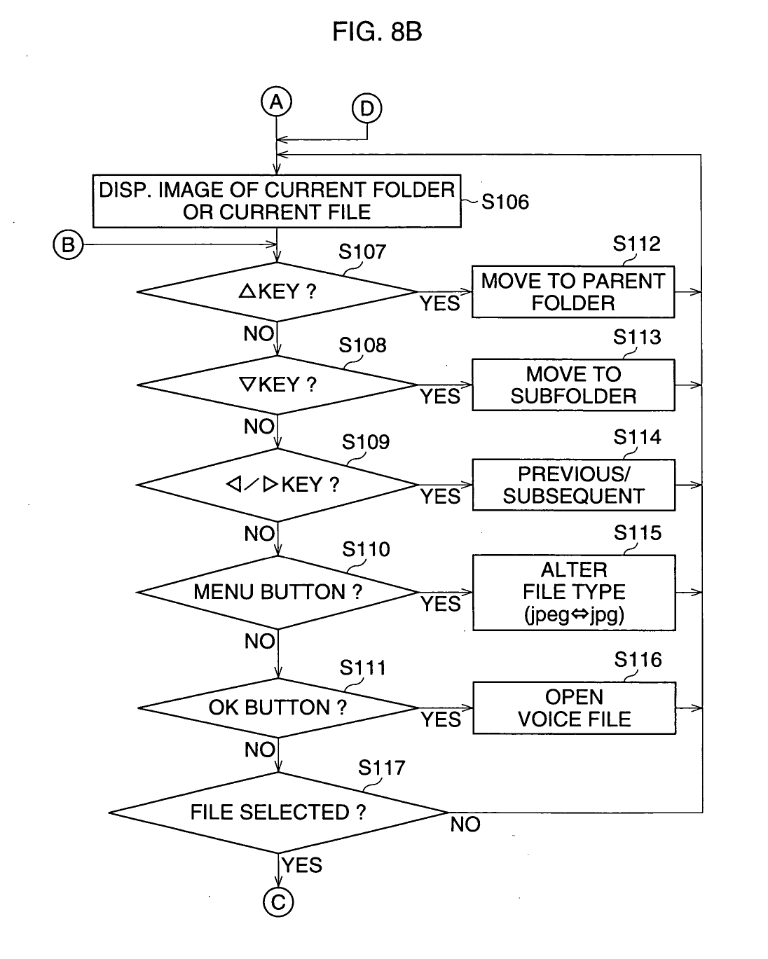

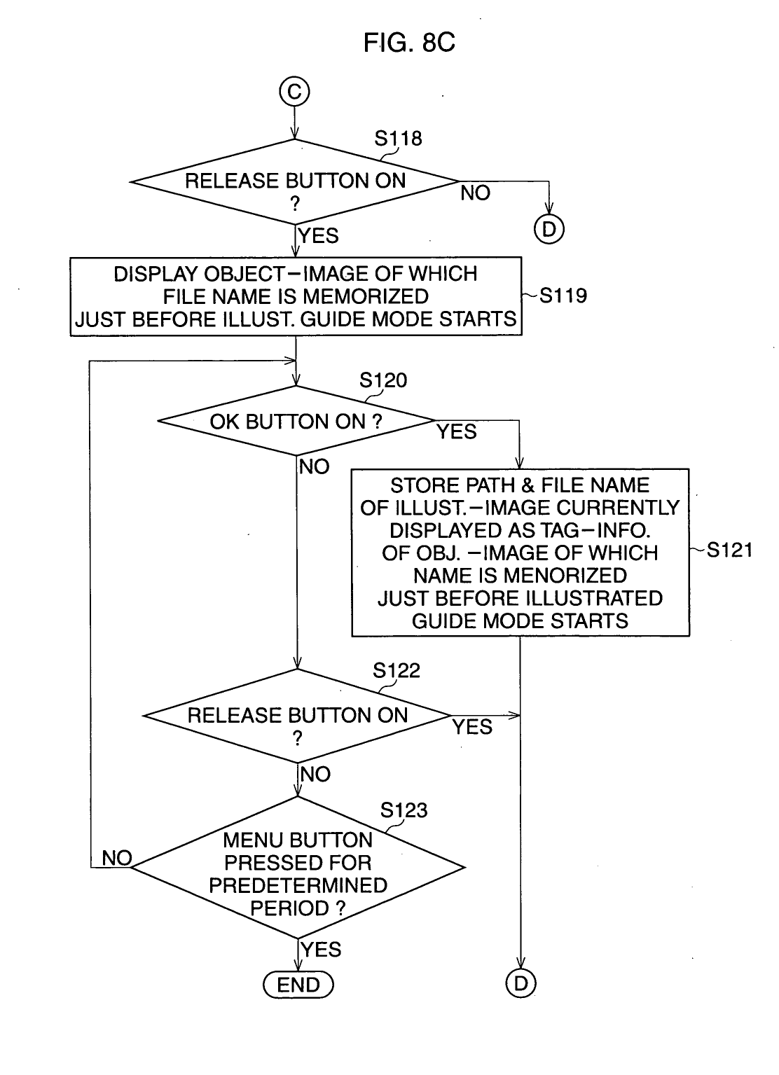

FIGS. 8A to 8C are a flowchart of the illustration-image indicating operation (the illustrated-guide mode) of the first embodiment. For example, this illustration-image indicating operation or the illustrated-guide mode starts when the menu button 15 is pressed for a predetermined period of time (longer than the normal press) while a still image captured by the imaging unit 21 is displayed on the screen of the image-indicating device 12. This may be carried out by an interrupt routine. Note that, before the illustrated-guide mode is selected and the illustration-image indicating operation is carried out, the processor 23 executes the operations that are required to carry out the functions of a normal digital camera (digital camera mode). Further, the processor 23 keeps information of the latest object image (still image) obtained by the imaging device and its file name, so that the information is used in order to bind an illustration image and an object image in the illustrated-guide mode (detailed later).

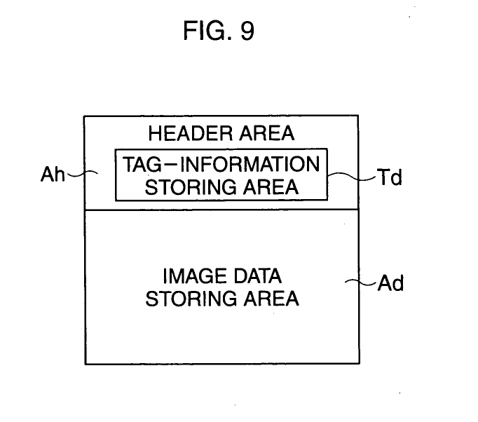

In Step S101, the file name of the object-image file, which corresponds to the still image that is captured by the imaging device and which is displayed on the image-indicating device 12, is temporally memorized and, for example, the picture displayed on the image-indicating device 12 is changed to a picture that indicates the fact that the illustration-image indicating operation is being carried out. In Step S102, the contents (tag-information) of a tag-information storing area Td of the object-image file, which corresponds to the captured still image that was displayed on the image-indicating device 12, are readout. As shown in FIG. 9, the object-image file includes a header area Ah which stores information relating to the image data and an image data storing area Ad which stores the image data. The tag-information storing area Td is allocated in the header area Ah. The tag-information storing area Td is an area for recording the result of a search carried out over the illustrated-guide data which was referred to in order to identify an object (e.g. a bird) that was imaged, and recorded as an the object-image file. The information relating to the above result may be referred to as search result tag-information. The path of an illustration-image file that was searched under the “ILLUSTRATED BIRD GUIDE” folder (more generally, “ILLUSTRATED GUIDE” folder relating to a certain kind of objects that are observed through the digital binoculars 10) may be used as the search result tag-information, for example, “\ILLUSTRATED BIRD GUIDE\AUTUMN\TOWN\SMALL\thrush.jpg”.

In Step S103, the current folder (current directory) is changed to a folder other than the “\DCIM” in the root folder (root directory). In the first embodiment, only the “\ILLUSTRATED BIRD GUIDE” folder exists in the root folder except for the “\DCIM” folder, so that the current folder is changed to the “\ILLUSTRATED BIRD GUIDE” folder. Note that, when there is a plurality of folders that corresponds to a plurality of illustrated-guides, the current folder may be changed to the root folder.

In Step S104, whether the search result tag-information, i.e. the path information, exists is determined. Namely, the search result tag-information in the header area Ah of the object-image file is referred to and whether the path of an illustration-image file is recorded is determined. When the path does not exist as the search result tag-information, the image of the “title.bmp” which corresponds to the current folder, such as the “\ILLUSTRATED BIRD GUIDE” folder, is displayed on the image-indicating device 12, in Step S106, and then Step S107 is carried out (detailed later). Note that, in Step S106, an image corresponding to the current folder or the image of the currently selected illustration-image file is displayed on the image-indicating device 12.

On the other hand, when a path is recorded as the search result tag-information, in Step S104, the current folder is changed to the folder which is designated by the path (the search result tag-information), in Step S105. Further, the image stored in the illustration-image file which is designated by the path is displayed on the screen of the image-indicating device 12. Namely, when the path is “\ILLUSTRATED BIRD\GUIDE\AUTUMN\TOWN\SMALL\thrush.jpg”, the current folder is changed from the “ILLUSTRATED BIRD GUIDE” to the “\ILLUSTRATED BIRD GUIDE\AUTUMN\TOWN\SMALL”. Further, the image of the file “thrush.jpg” is displayed on the image-indicating device 12, as shown by (a) of FIG. 5. The process then proceeds to Step S107.

Whether the cursor keys 17U, 17D, 17R, and 17L, the menu button 15, or the OK button 18 has been operated is determined in Steps S107 to S111 and respective processes are executed according to the operation. Namely, in Step S107, whether the up-key 17U is pressed is determined and in Step S108, whether the down-key 17D is pressed is determined. Further, in Step S109, whether the right-key 17R or the left-key 17L is pressed is determined. Furthermore, whether the menu button 15 is pressed and whether the OK button 18 is pressed is determined in Steps S110 and S111, respectively.

When it is determined in Step S107 that the up-key 17U is pressed, the current folder is changed to the parent folder in Step S112. The process then returns to Step S106 and the image corresponding to the new current folder is displayed on the screen of the image-indicating device 12. For example, when the up-key 17U is pressed and when the current folder is at “\ILLUSTRATED BIRD GUIDE\AUTUMN\TOWN” and when the corresponding image, such as (c) in FIG. 7, is displayed on the image-indicating device 12, the current folder is changed to “\ILLUSTRATED BIRD GUIDE\AUTUMN” and the image of (b) in FIG. 7 is then displayed on the image-indicating device 12. However, when the parent is the root folder, the current folder will not be changed.

When it is determined, in Step S108, that the down-key 17D is pressed, subfolders of the current folder are searched and the current folder is changed to the first folder that was found in the above search. Further, if no subfolder is found, the illustration-image file that is found first is selected. Note that, it is preset to select a “*.jpg” file as a default. When a subfolder or a file is selected in Step S113, the image corresponding to the selected folder or file is displayed in Step S106. For example, if the down-key 17D is pressed when the current folder is at “\ILLUSTRATED BIRD GUIDE\AUTUMN\TOWN”, the subfolder “LARGE” is found first and the corresponding image, i.e. the file “size1.bmp”, is displayed on the image-indicating device 12. Further, if the down-key 17D is pressed when the current folder is at “\ILLUSTRATED BIRD GUIDE\AUTUMN\TOWN\SMALL”, the JPEG files “*.jpg” are searched, since the current folder has no subfolder. For example, when the file “thrush.jpg” is firstly found, the image shown in (a) of FIG. 5 is displayed on the image-indicating device 12.

When it is determined, in Step S109, that the right-key 17R or the left-key 17L is pressed, a previous or subsequent folder (or file) is searched in Step S114. For example, when the left-key 17L is pressed, the previous folder (or file) is searched and when the right-key 17R is pressed, the subsequent folder (or file) is searched. If the right-key 17R is pressed when the current folder is at “\ILLUSTRATED BIRD GUIDE\AUTUMN\MOUNTAIN”, the current folder is changed to “\ILLUSTRATED BIRD GUIDE\AUTUMN\SEA”, for example. The process then returns to Step S106, such that the image that corresponds to the “\ILLUSTRATED BIRD GUIDE\AUTUMN\SEA” is displayed. Note that, the alteration of current folder due to the right-key 17R is carried out cyclically in the following order, “MOUNTAIN”→“SEA”→“TOWN”→“MOUNTAIN” and the alteration due to the left-key 17L is cyclically carried out in the opposite order. Further, the same is true with the file selection, so that the selection of a file is cyclically altered by operations of the right-key 17R and the left-key 17L and the image of the selected file is displayed on the image-indicating device 12.

When it is determined, in Step S110, that the menu button 15 is pressed, the type of the file that is adopted when selecting a file in Step S113 and Step S114 is altered in Step S115 and the process returns to Step S106. Namely, by default, a file with the extension “jpg” (file “*.jpg”) is subjected to the file selection. However, when the menu button 15 is pressed, the subject of the file selection is altered to a file with the extension “jpeg” (file “*.jpeg”). Contrary, when the menu button 15 is pressed while a “*.jpeg” file is being selected, the file selection is altered to the “*.jpg” files. For example, if the menu button 15 is pressed while the file “thrush.jpg” is selected and the illustration-image, such as (a) of FIG. 5, is being displayed, the file selection will be altered to the “thrush.jpeg”, so that the image shown at (b) of FIG. 5 will be displayed on the image-indicating device 12. Note that, nothing will happen in this step when no file is selected.

When it is determined that the OK button 18 is pressed, in Step S111, a voice file corresponding to the selected file is opened in Step S116, so that the song of the bird, which is displayed on the image-indicating device 12, is output from the speaker 30 (see FIG. 2) and the process returns to Step S106. For example, if the OK button 18 is pressed when the file “thrush.jpg” is selected, the song of the thrush, which is recorded as “thrush.wav” is played. Note that, nothing will happen in this step when no file is selected.

On the other hand, when none of the cursor keys 17U, 17D, 17R, and 17L, the menu button 15, and the OK button 18 are operated, whether a file is selected is determined in Step S117. When none of the files are selected, Steps S106 to S117 are repeated. When a file has been selected, the steps after Step S118, which are shown in FIG. 8C are carried out.

In Step S118, whether the release button 14 is pressed is determined. When the release button 14 is pressed, the object image corresponding to a file name that was memorized just before starting the illustration-image indicating operation (the illustrated-guide mode) is displayed on the screen of the image-indicating device 12. Namely, the user can verify the object image by operating the release button 14. If the release button 14 is not pressed, the process returns to Step S106.

In Step S120, whether the OK button 18 is pressed is determined. When it is determined that the OK button 18 is pressed, the process proceeds to Step S121 and the path of the current illustration image displayed on the image-indicating device 12 is stored as the search result tag-information in the tag-information storing area Td of the object-image file, in which the file name is memorized (the file which corresponds to the object-image displayed on the screen of the image-indicating device 12 in Step S119). Namely, the path of the illustration image can be stored in the header area Ah of the object-image file, when the object image is confirmed and the searched illustration image of the illustrated-guide data is determined as being identical to the object image (such as a captured image of a bird) by the user, by pressing the OK button 18. Note that, when the process of Step S121 ends, the process returns to Step S106 and the preceding processes are repeated.

On the other hand, when it is determined in Step S120 that the OK button 18 is not pressed, whether the release button 14 is pressed is determined. When the release button 14 is pressed, the process returns to Step S106. Further, when it is determined in Step S122 that the release button 14 in not pressed, whether the menu button 15 is pressed for a predetermined term (which is longer than the normal press operation) is determined. If the menu button 15 is not pressed for the predetermined period, the process returns to Step S120 and the succeeding processes are repeated, such that the program waits for an input. On the other hand, when the menu button 15 is pressed for the predetermined period, this illustration-image indicating operation (the illustrated-guide mode) ends, so that the process returns to the processes for a normal digital operation.

As described above, in the first embodiment, objects or targets of an observation, such as the bird in the embodiment, are classified based on various attributes and each category is hierarchally combined as a hierarchal folder system. Further, files that store information relating to the observation targets, including illustration-image files and voice files of the illustrated-guide data, are stored in the recording medium based on the above hierarchal classification. Thereby, the illustration image files which relate to the observation targets can be easily and swiftly searched along the hierarchal classification, by a user, so that the searched illustration image can be displayed on the image-indicating device of the digital binoculars for reference. Therefore, the image of an object that is being observed can be easily compared to the above searched illustration image. Further, the information relating to an illustration image, such as voice, name, and the like, can also easily be cited in the present embodiment. This also helps identification of the observation target.

Further, in the first embodiment, the illustrated-guide data corresponding to the stored object image can be immediately referred to, without searching the files again, even some time after the first search, since the result of the search of the illustrated-guide data can be annexed to the object image as tag information. Further, in the first embodiment, the search operation can be swiftly carried out, since the current folder is automatically changed to the folder corresponding to the object image, when the illustrated-guide mode is started while the above object image with effective search result tag-information is displayed on the image-indicating device.

Furthermore, since the observation target is classified by the hierarchical structure of the folders (directories), the above search system can be constructed by using a significantly simple structure, so that users can easily construct a database by theirselves.

Note that, subjects other than the bird can also be chosen as an observation target. For example, the observation target may be animals, sports players, cars, and so on. When the targets are sports players, images of the players, profile, theme song, and so on maybe stored as the illustrated-guide data, and a team name, nationality, age, league, and so on, can be adopted as categories for the classification. Further, the number of illustrated guides stored in the recording medium may also be plural.

In the first embodiment, the folder-images, which represent the respective folders, are all allocated in the illustrated-guide folder, such as the “ILLUSTRATED BIRD GUIDE”. However, the folder-images can be allocated in each corresponding folder separately. Further, in the first embodiment, JPEG and BMP files are adopted as the image files and the WAV files are adopted as the voice files. However, any suitable type of image file and voice file can be adopted. Further, the correspondence between the folders and the folder-image files may be established by the order of the folders and files or by establishing correspondence between the folder names and the file names.

In the first embodiment, although the illustration-image indicating operation is carried out in the digital binoculars, the operation can be carried in the personal computer with the illustrated-guide data, by transmitting an object image from the digital binoculars to the personal computer. Further, although each of the object-image files stored a path as the tag-information, in the present embodiment, the correspondence between the object-image files and the illustration-image files may be stored in a separate file or an exclusive file.

Furthermore, the present embodiment can be applied to a digital camera or any type of optical apparatus provided with the digital camera function.

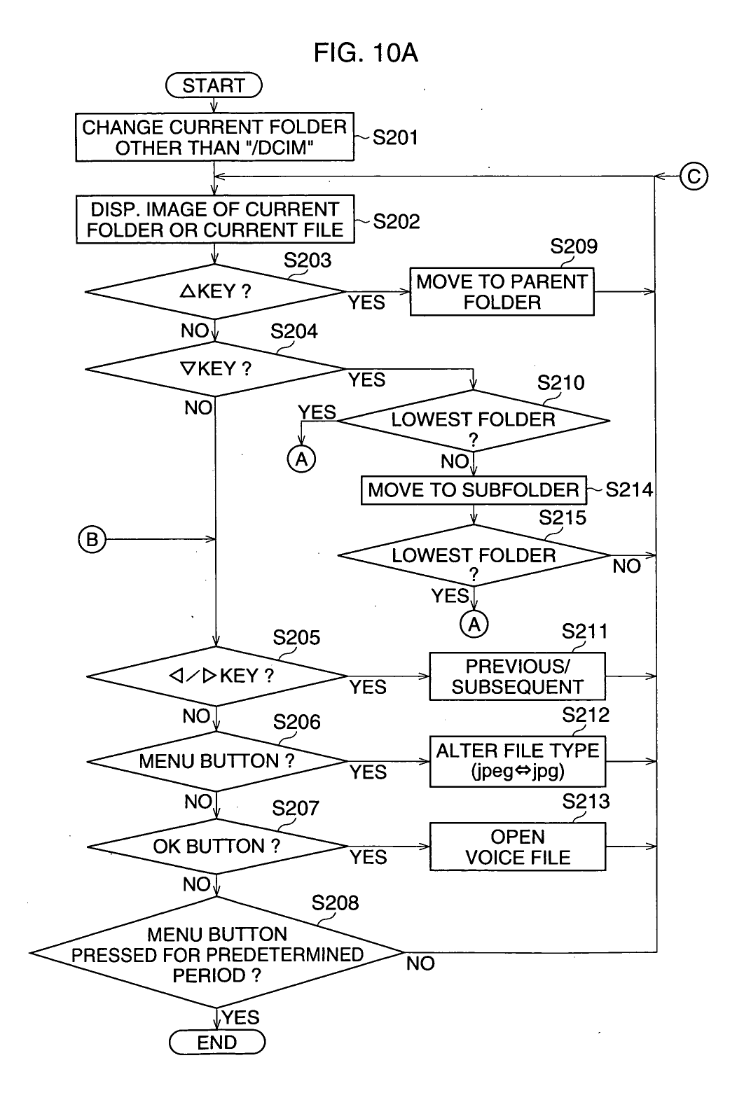

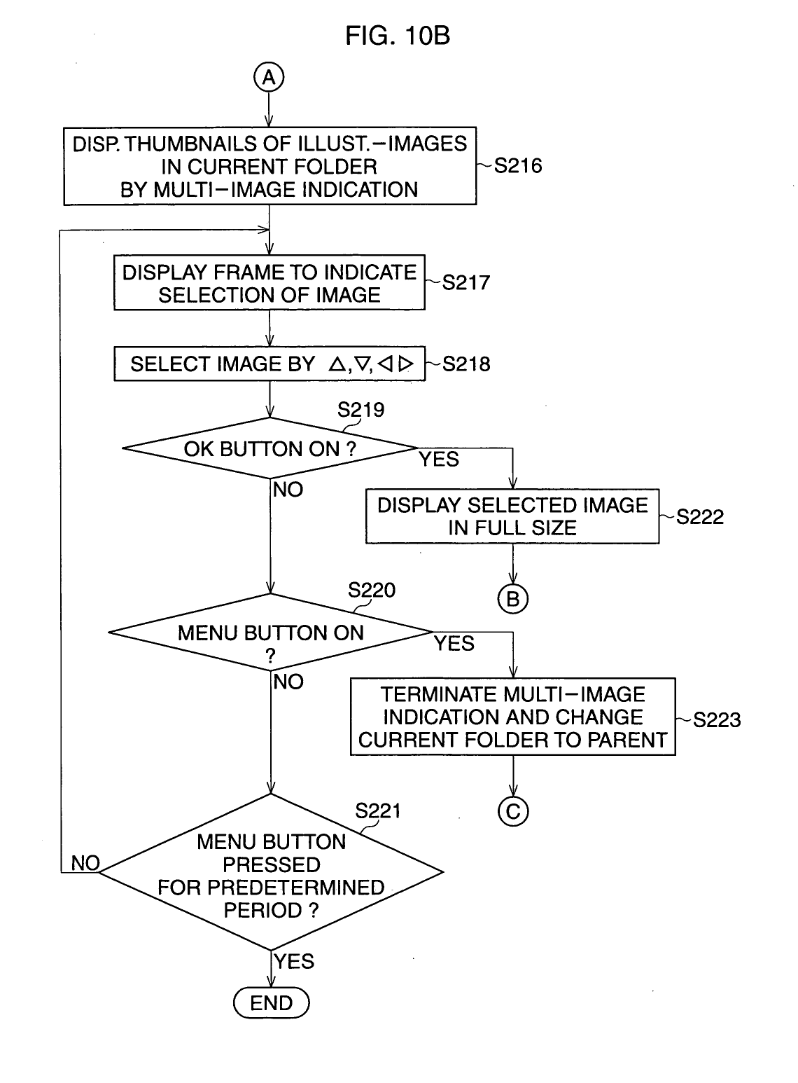

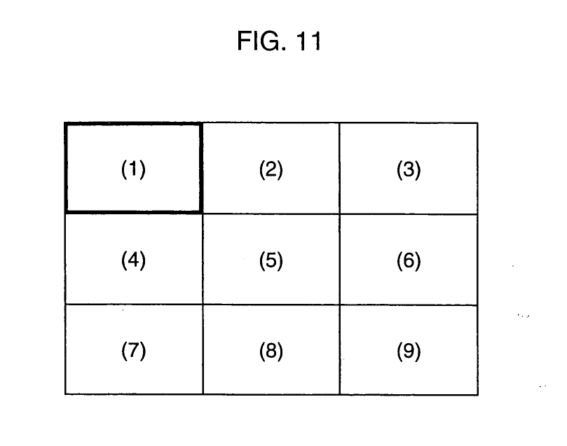

With reference to FIGS. 10A and 10B and FIG. 11, the second embodiment will be explained. The structures other than the illustration-image indicating operation are the same as those of the first embodiment. Therefore, only the structure dissimilar to that in the first embodiment will be explained.

FIGS. 10A and 10B are a flowcharts of the illustration-image indicating operation (the illustrated-guide mode) of the second embodiment. For example, this illustration-image indicating operation or the illustrated-guide mode starts when the menu button 15 is pressed for a predetermined period of time (longer than the normal press) while a still image captured by the imaging unit 21 is displayed on the screen of the image-indicating device 12, and may be carried out by an interrupt routine. Note that, before the illustrated-guide mode is selected and the illustration-image indicating operation is carried out, the processor 23 executes the operations that are required to achieve functions of a normal digital camera.

In Step S201, a folder allocated in the root folder of the recording medium M (e.g. IC memory card), other than the “DCIM”, is searched and the current folder is changed to the searched folder. In the second embodiment, other than the “\DCIM” folder, only the “\ILLUSTRATED BIRD GUIDE” folder exists in the root folder so that the current folder is changed to the “\ILLUSTRATED BIRD GUIDE” folder. In Step S202, the folder-image “title.bmp” that corresponds to the current “\ILLUSTRATED BIRD GUIDE” folder is displayed on the image-indicating device 12. In Step S202, an image corresponding to the current folder or the image of the currently selected illustration-image file is displayed on the image-indicating device 12.

Whether the cursor keys 17U, 17D, 17R, and 17L, the menu button 15, or the OK button 18 has been operated is determined in Steps S203 to S208 and respective processes (Steps S209-S213) are executed as to the operation. Namely, in Step S203, whether the up-key 17U is pressed is determined and in Step S204, whether the down-key 17D is pressed is determined. Further, in Step S205, whether the right-key 17R or the left-key 17L is pressed is determined. Furthermore, whether the menu button 15 is pressed and whether the OK button 18 is pressed is determined in Steps S206 and S207, respectively.

When it is determined in Step S203 that the up-key 17U is pressed, the current folder is changed to the parent folder in Step S209. The process then returns to Step S202 and the image corresponding to the new current folder is displayed on the screen of the image-indicating device 12. For example, when the up-key 17U is pressed, where the current folder is at “\ILLUSTRATED BIRD GUIDE\AUTUMN\TOWN” and the corresponding image, such as (c) of FIG. 7, is displayed on the image-indicating device 12, the current folder is changed to “\ILLUSTRATED BIRD GUIDE\AUTUMN” and the image of (b) in FIG. 7 is then displayed on the image-indicating device 12. However, when the parent is the root folder, the current folder will not be changed.

When it is determined, in Step S204, that the down-key 17D is pressed, whether the current folder is the lowest folder (the folder which has no subfolder) is determined in Step S210. If the current folder is the lowest folder (i.e. the current folder has no subfolder), the process proceeds to Step S216 (detailed later). On the other hand, when it is determined that the current folder is not the lowest folder, subfolders of the current folder are searched, in Step S214 and the current folder is changed to the first folder that is found in the above search. Further, in Step S215, whether the new current folder is the lowest folder is determined again. When it is determined, in Step S215, that the current folder is the lowest folder, the process proceeds to Step S216, similar to Step S210.

On the other hand, when it is determined, in Step S215, that the current folder is not the lowest folder, the image corresponding to the selected folder is displayed in Step S202. For example, if the down-key 17D is pressed when the current folder is at “\ILLUSTRATED BIRD GUIDE\AUTUMN\TOWN”, the subfolder “LARGE” is firstly found and the corresponding image, i.e. the file “size1.bmp”, is displayed on the image-indicating device 12. Further, when a file has been selected, i.e. when the image of “*.jpg” or “*.jpeg” is being displayed, the current folder should be the lowest folder, so that the process proceeds to Step S216 when the down-button 17D is pressed.

When it is determined, in Step S205, that the right-key 17R or the left-key 17L is pressed, a previous or subsequent folder (or file) is searched in Step S211. For example, when the left-key 17L is pressed, the previous folder (or file) is searched and when the right-key 17R is pressed, a subsequent folder (or file) is searched. If the right-key 17R is pressed when the current folder is at “\ILLUSTRATED BIRD GUIDE\AUTUMN\MOUNTAIN”, the current folder is changed to “ILLUSTRATED BIRD GUIDE\AUTUMN\SEA”, for example. The process then returns to Step S202, such that the image that corresponds to the “\ILLUSTRATED BIRD GUIDE\AUTUMN\SEA” is displayed. Note that, the alteration of current folder due to the right-key 17R is carried out cyclically in the following order, “MOUNTAIN”→“SEA”→“TOWN”→“MOUNTAIN” and the alteration due to the left-key 17L is cyclically carried out in the opposite order. Further, the same is true with the file selection, so that the selection of a file is cyclically altered by operations of the right-key 17R and the left-key 17L and the image of the selected file is displayed on the image-indicating device 12.

When it is determined, in Step S206, that the menu button 15 is pressed, the type of file that is adopted when selecting a file in Step S210 and Step S211 is altered in Step S212 and the process returns to Step S202. Namely, by default, a file with the extension “jpg” (file “*.jpg”) is subjected to the file selection. However, when the menu button 15 is pressed, the subject of the file selection is altered to a file with the extension “jpeg” (file “*.jpeg”). Further, when the menu button 15 is pressed while a “*.jpeg” file is being selected, the file selection is altered to the “*.jpg” file. For example, if the menu button 15 is pressed while the file “thrush.jpg” is being selected and the illustration-image, such as (a) of FIG. 5, is displayed, the file selection will be altered to the “thrush.jpeg”, so that the image shown at (b) of FIG. 5 will be displayed on the image-indicating device 12. Note that, nothing will happen in this step when no file is selected.

When it is determined that the OK button 18 has been pressed, in Step S207, a voice file corresponding to the selected file is opened in Step S213, so that a song of the bird which is displayed on the image-indicating device 12, is output from the speaker 30 (see FIG. 2) and the process returns to Step S202. For example, if the OK button 18 is pressed when the file “thrush.jpg” is selected, the song of the thrush, which is recorded as “thrush.wav” is played. Note that, nothing will happen in this step when no file is selected.

When it is determined, in Step S208, that the menu button 15 has been pressed for the predetermined period, this illustration-image indicating operation (the illustrated-guide mode) ends, so that the process returns to the processes for the normal digital operation. Further, when the menu button 15 is not pressed for the predetermined period, the process returns to Step S202 and the above processes are repeated.

Next, the processes that follow Steps S216, which are carried out when the current folder is the lowest folder, will be explained. In Step S216, the illustration images with the extension “jpg” in the current folder are displayed as a multi-image indication, as shown in FIG. 11. In FIG. 11, 3×3 multi-image indication, where nine thumbnail images (1)-(9) are concurrently displayed on the image-indicating device 12, is schematically shown, as an example.

In Step S217, a frame to indicate a thumbnail image to be selected from the thumbnail images (1)-(9) is displayed. For example, by default, the frame appears on the periphery of the upper left corner thumbnail image (1) at first. In Step S218, the frame may be shifted by operating the cursor keys 17U, 17D, 17R, and 17L. Namely, when the right-key 17R is pressed, the frame will shift to the thumbnail image on the right, next to the current thumbnail image, and when the left-key 17L is pressed, the frame will shift to the left. Further, when the up-key 17U is pressed, the frame will shift to the upper neighboring thumbnail image and when the down-key 17D is pressed, the frame will shift to the lower neighboring thumbnail image.

In Steps S219 to S221, whether the OK button 18 and the menu button 15 has been pressed is determined and the process corresponding to the operation is carried out. When the OK button 18 is pressed, the image “*.jpg” that corresponds to the selected thumbnail image (which is surrounded by the frame) is fully displayed, in Step S222, on the screen of the image-indicating device 12 and the process proceeds to Step S205. Further, when it is determined, in Step S 220, that the menu button 15 is normally pressed (not for a long period), the current folder is changed to the parent folder, in Step S223, and the multi-image indication ends. The process then returns to Step S202 and the above-described processes are repeated. On the other hand, when it is determined that the menu button 15 is pressed for the predetermined period, this illustration-image indicating operation ends. Note that, when neither the OK button 18 nor the menu button 15 is operated, the processes that follow Step S217 will be repeated.

As described above, according to the second embodiment, the effects similar to those of the first embodiment can be obtained. Further, in the second embodiment, the thumbnail images of the illustration images in the lowest subfolder can be displayed in a multi-image indication mode, so that an image corresponding to the observation target can be easily and swiftly searched, in order, and the observation target can be easily and swiftly compared with an illustrated image, which was searched with reference to the multi-image indication.

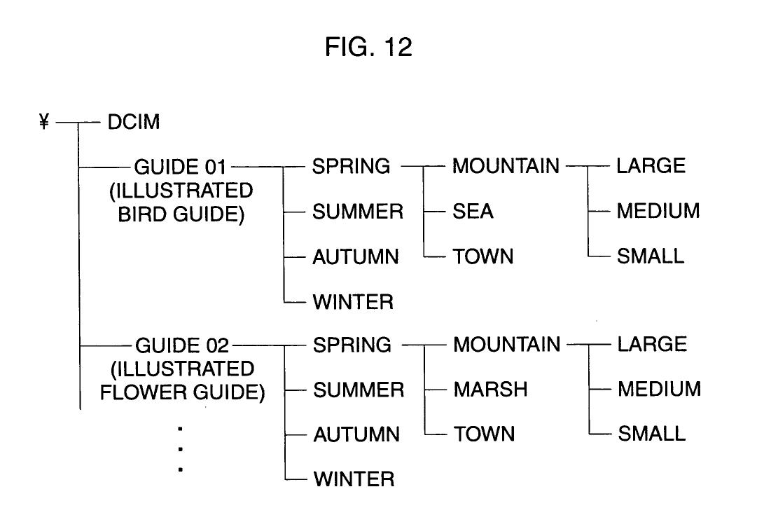

Next with reference to FIGS. 12 to 14, a third embodiment of the present invention will be explained. The mechanical structure and the electrical structure of the third embodiment are the same as those of the first and second embodiments. What are dissimilar to the first and second embodiments are components relating to an illustration-image indicating operation. Therefore only the components particular to the third embodiment will be explained.

FIG. 12 illustrates an example of the hierarchical structure of folders (directories) in the recording medium M. As shown in FIG. 12, a plurality of folders, such as “DCIM”, “GUIDE01”, “GUIDE02”, and so on, exist in the root folder (root directory) of the recording medium M. The respective folders with a name “GUIDE”+“numeral”, such as “GUIDE01” and “GUIDE02”, correspond to some field of an electronic illustrated guide. In this embodiment, the folder “GUIDE01” corresponds to the “ILLUSTRATED BIRD GUIDE” and the folder “GUIDE02” corresponds to the “ILLUSTRATED FLOWER GUIDE”.

For example, the folder “GUIDE01” has the same hierarchal folder structure as the “ILLUSTRATED BIRD GUIDE” folder in the first and second embodiments, which is represented in FIG. 3. Namely, the hierarchal combination of categories of the seasons (“SPRING”, “SUMMER”, “AUTUMN”, and “WINTER”), the scenes (“MOUNTAIN”, “SEA”, and “TOWN”), and the sizes (“LARGE”, “MEDIUM”, and “SMALL”). Further, the hierarchal structure of the “GUIDE02” folder is the same as the folder “GUIDE01”, except for the subfolder “MARSH” which takes the place of the subfolder “SEA” of the “GUIDE01” folder. Note that, in FIG. 12, only the folders “MOUNTAIN”, “SEA”/“MARSH”, and “TOWN” of the “SPRING” and only the folders “LARGE”, “MEDIUM”, and “SMALL” of the “MOUNTAIN” are illustrated, and the other subfolders are neglected for convenience.

In the same way as the first and second embodiment, the illustration image files of birds that are classified in accordance with the above seasons, scenes, and sizes, and the files including the information relating to these illustration image files are stored in the “LARGE”, “MEDIUM”, and “SMALL” folders, which exist under the respective seasons and scenes of the “GUIDE01” folder. Similarly, the illustration image files of flowers that are classified in accordance with the above seasons, scenes, and sizes, and files including information relating to these illustration image files are stored in the “LARGE”, “MEDIUM”, and “SMALL” folders, which exist under the respective seasons and scenes of the “GUIDE02” folder. This is true for the other illustrated-guide folders.

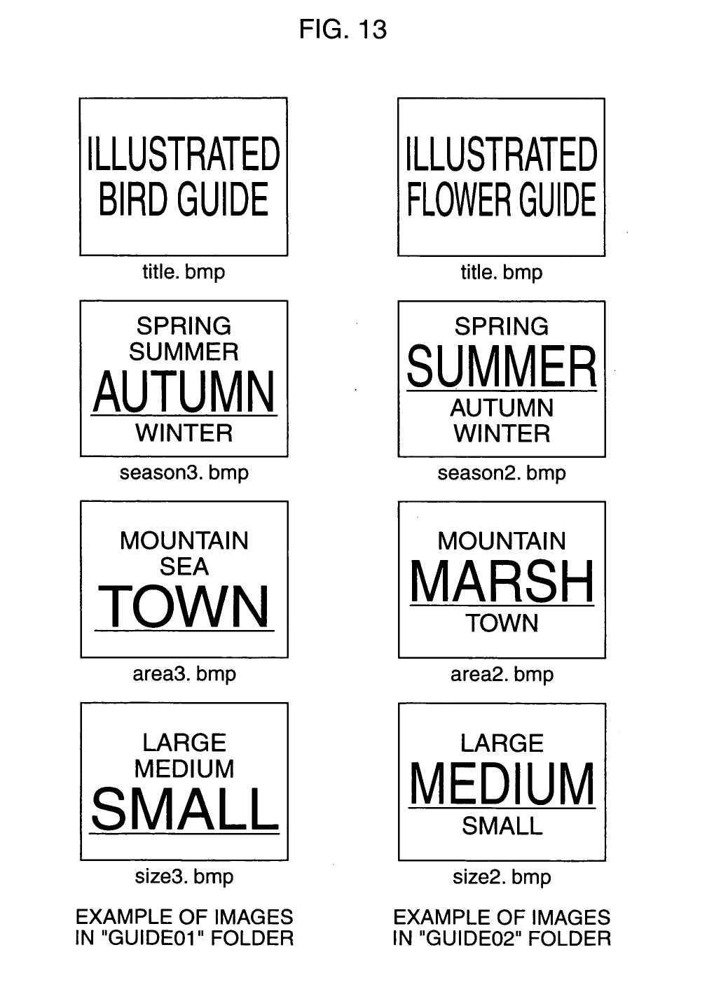

In FIG. 13, an example of the bitmap images stored in the folders “GUIDE01” and “GUIDE02” are depicted. In the left column, the folder-images of the “title.bmp” (ILLUSTRATED BIRD GUIDE), “season3.bmp” (AUTUMN), “area3.bmp” (TOWN), and “size3.bmp” (SMALL), allocated in the folder “GUIDE01” of the illustrated bird guide, are illustrated (the same as those in FIG. 7). Further, in the right column, the folder-images of the “title.bmp” (ILLUSTRATED FLOWER GUIDE), “season2.bmp” (SUMMER), “area2.bmp” (MARSH), and “size2.bmp” (MEDIUM), allocated in the folder “GUIDE01” of the illustrated flower guide, are illustrated.

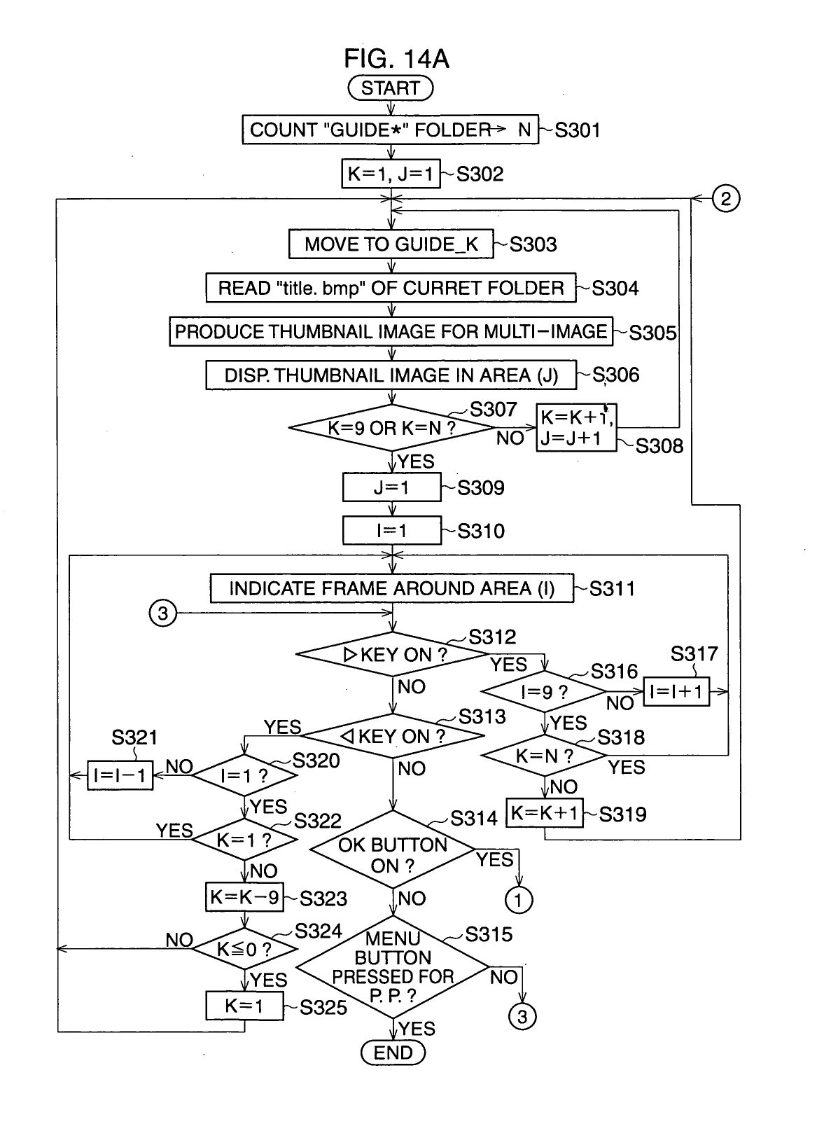

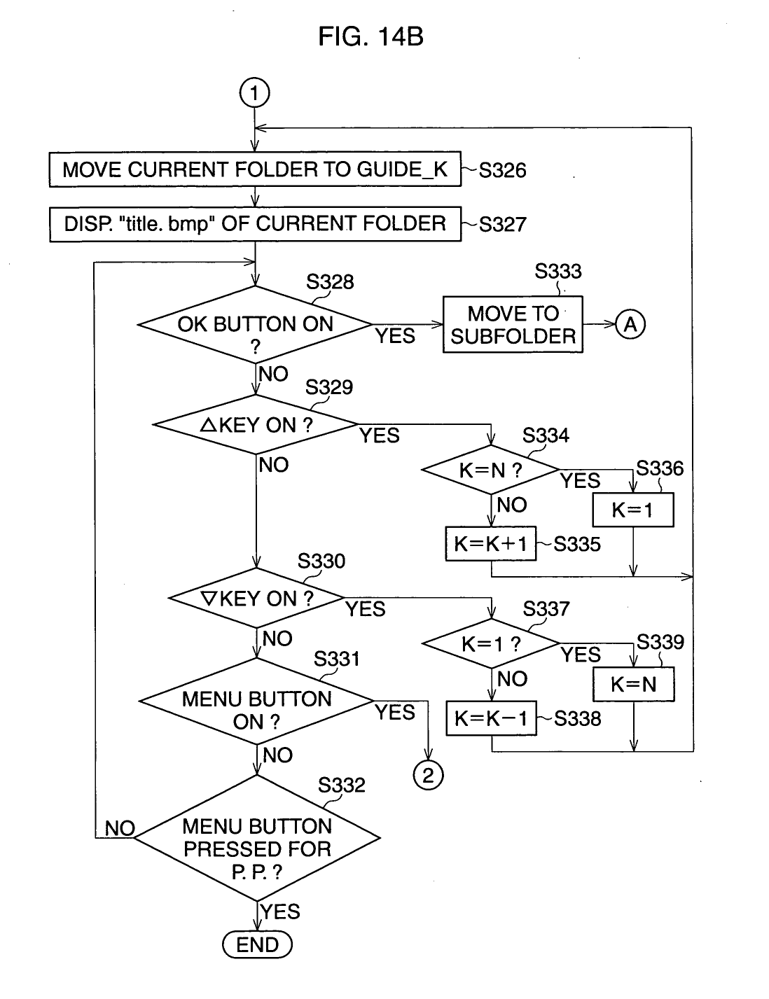

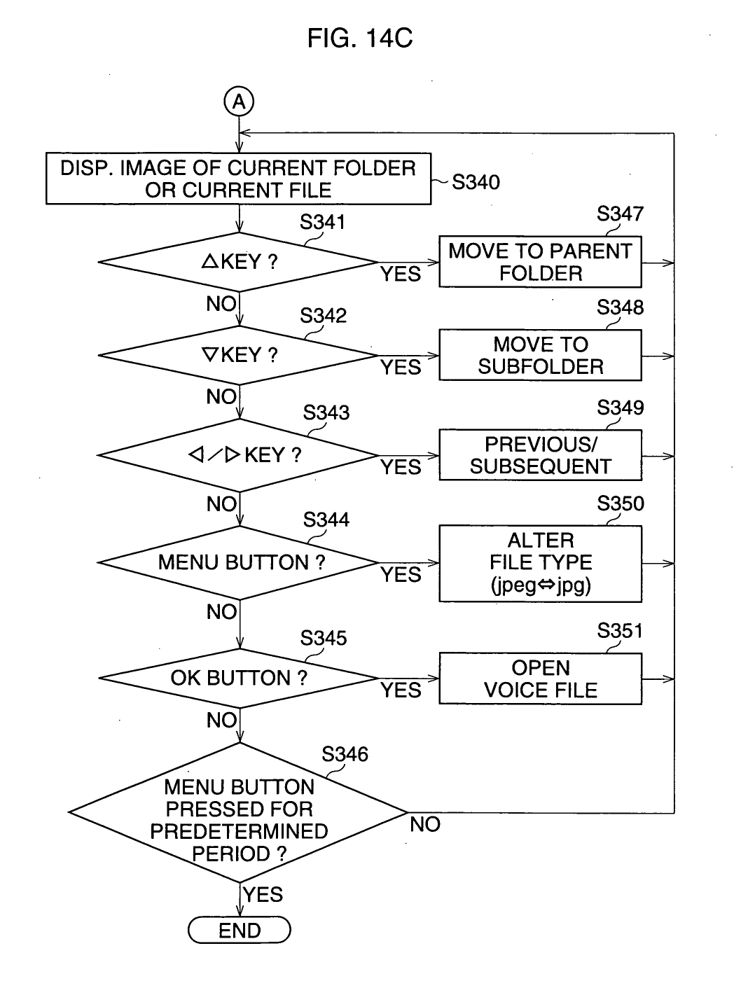

FIGS. 14A to 14C are a flowchart of the illustration-image indicating operation (the illustrated-guide mode) of the third embodiment. For example, this illustration-image indicating operation or the illustrated-guide mode starts when the menu button 15 is pressed for the predetermined period of time.

In Step S301, folders “GUIDE*”, other than the “DCIM” folder in the root folder of the recording medium M, are searched, so that the number of folders is detected and stored as the variable “N”. In Step S302, the variables “K” and “J” are initialized as “1”. In the third embodiment, nine thumbnail images of the folder-images (“title.bmp”) corresponding to each of the illustrated-guide folders (“GUIDE*”) are, for example, displayed on the image-indicating device 12 as the 3×3 multi-image indication of FIG. 11. The variable K corresponds to the two-digit numeral included in the folder name “GUIDE*” and the variable “J” corresponds to the respective nine thumbnail images of the 3×3 multi-image indication of FIG. 11. Namely, the variable “J” represents the numbers (1)-(9) of FIG. 11.

In Step S303, the current folder is changed to the folder “GUIDE_K” (hereinafter, an illustrated-guide folder of which the last two characters correspond to the variable “K”, will be referred to as “GUIDE_K”). In the present embodiment, the folder “GUIDE01” corresponds to the illustrated bird guide, so that the current folder is changed to the illustrated bird guide folder at the beginning of the illustration-image indicating operation, since the initial value of the variable “K” is “1”. In Step S304, the bitmap data “title.bmp”, which represents the current folder, is read into the working area (e.g. work RAM 28), and in Step S305, the bitmap data in the working area is thinned out for the 3×3 multi-image indication, such that the thumbnail image is produced. Further, in Step S306, the thumbnail image that was produced in Step S305 is displayed in the area (J) of the multi-image indication of FIG. 11.

In Step S307, whether the variable J=9 (the maximum value) or the variable K=N (the maximum value) is determined. When both of the variables “J” and “K” have not yet reached the maximum values, the variables “J” and “K” are incremented by one, in Step S308, and the process returns to Step S303, so that the above processes are repeated. Namely, the “title.bmp” of the next folder “GUIDE_K+1” is read into the working area and its thumbnail image is displayed in the corresponding area of the multi-image indication of the image-indicating device 12. Thereby, when the variable “J” reaches the maximum value “9”, nine thumbnail images, which correspond to each of nine “GUIDE*” folders, are displayed in each of the multi-image indicating areas (J) of FIG. 11.

On the other hand, when it is determined, in Step S307, that either of the variables J or K has reached the respective maximum values “9” and “N”, i.e., when all nine thumbnail images have already been displayed, the value of the variable “J” is reset to “1” in Step S309 and the value of a variable “I” is initialized to “1” in Step S310. The variable “I” represents an image (folder-image or illustration-image) to be selected from the thumbnails images displayed in each of the areas (1)-(9) of the image-indicating device 12. In Step S311, based on the value of the variable “I”, the frame is displayed around the thumbnail image corresponding to the area (I) of the multi-image indication to indicate the image (folder-image or illustration-image) to be selected. Note that, hereinafter, the thumbnail image in the area (I) will be referred to as thumbnail image (I).

In Steps S312-S315, whether the cursor keys 17R and 17L, the menu button 15, or the OK button 18 have been operated is determined, and respective processes are executed according to the operation. Namely, in Step S312, whether the right-key 17R is pressed is determined and in Step S313, whether the left-key 17L is pressed is determined. Further, in Step S314, whether the OK button 18 is pressed is determined and in Steps S315 whether the menu button 15 is pressed for the predetermined period is determined.

When it is determined, in Step S312, that the right-key is pressed, whether the value of the variable “I” is the maximum number 9 is determined in Step S316. When the value of the variable “I” is not the maximum number 9, the value of the variable “I” is incremented by 1 in Step S317 and the process returns to Step S311. Namely, the indication of the frame is changed to the thumbnail image (I+1) from the current thumbnail image (I). On the other hand, when it is determined, in Step S316, that I=9, whether the value of the variable “K” has reached the maximum value “N” is determined in Step S318. When K=N, the process returns to Step S311 and the above-described processes are repeated. Namely, when the frame is indicating the last thumbnail image (9), at the lower right of the multi-image indication, and when this image is corresponding to the last folder “GUIDE_N” in the root folder, the current indication will be maintained even though the right-key 17R is pressed.

On the other hand, when it is determined in Step S3-18 that “K” is not equal to “N”, the value of the variable “K” is incremented by 1 in Step S319 and the process returns to Step S303. Namely, when the frame is indicating the last thumbnail image (9) of the multi-image indication, and when this image does not correspond to the last folder “GUIDE_N” of the root folder, the thumbnail images corresponding to the folders “GUIDE_K+1” to “GUIDE_K+9” will be displayed on the image-indicating device 12 as the multi-image indication.

Further, when it is determined, in Step S313, that the left-key 17L is pressed, whether the value of the variable “I” is equal to 1 is determined in Step S320. When “I” is not equal to 1, the value of the variable “I” is decremented by 1 in Step S321, and the process returns to Step S311. Namely, the current frame indication is changed form the thumbnail image (I) to the thumbnail image (I−1). When it is determined, in Step S320, that I=1, whether the value of the variable “K” is equal to 1 is determined in Step S322. When K=1, the process returns to Step S311 and the above-described processes are repeated. Namely, when the frame is indicating the first thumbnail image (1), at the upper left of the multi-image indication, and when this image correspond to the first folder “GUIDE_{—}1” in the root folder, the current indication will be maintained even though the left-key 17L is pressed.

On the other hand, when “K” is not equal to 1 in Step S322, the value of the variable “K” is changed to K−9 in Step S323, and whether the value of the variable “K” is less than or equal to 0 is determined. When it is determined that the value of the variable “K” is not less than or equal to 0, the processes from Step S303 to Step S308 will be repeated with the value of the variable “K” altered by new value (K−9). Namely, if the left-key 17L is pressed when the frame is indicating the first thumbnail image (1), at the upper left of the multi-image indication, and when there exist more than or equal to ten folders having the number “K” smaller than the folder “GUIDE_K” with the current “K”, thumbnail images that corresponding to nine folders having the number less than “K” will be read from each of the folders, in Steps S303 to S308, and displayed on the image-indicating device as the multi-image indication. Further, when it is determined in Step S324 that the value of the variable “K” is less or equal to 0, the value of the variable “K” is reset to 1, and Step S303 to S308 are repeated. Namely, if the left-key 17L is pressed when the frame is indicating the first thumbnail image (1), at the upper left of the multi-image indication, and when there exist no more than ten folders having a number “K” smaller than the folder “GUIDE_K” with the current “K”, thumbnail images that corresponding to the folders “GUIDE_{—}01” to “GUIDE_{—}09” with K=1−9, will be read from each of the folders, in Steps S303 to S308, and displayed on the image-indicating device as the multi-image indication.

Further, whether the respective OK button 18 is pressed or the menu button 15 is pressed for the predetermined period is determined in Steps S314 and S315. When the OK button 18 is not pressed and the menu button 15 is not depressed for a predetermined period, the processes succeeding Steps S312 are repeated. On the other hand, when the OK button is pressed the process proceeds to Step S326. Further, when the menu button 15 is depressed for the predetermined period, this illustration-image indicating operation ends.

When the OK button 18 is pressed and the selection of the folder “GUIDE_K” corresponding to the thumbnail image, which is indicated by the frame, is decided, the current folder, which was the root folder, is changed to the folder “GUIDE_K” in Step S326. Further, in Step S327, the image of the “title.bmp”, which corresponds to the current folder “GUIDE_K” is fully displayed on the image-indicating device 12.

In Steps S328 to S332, whether the up-key 17U, the down-key 17D, the OK button 18, and the menu button 15 are pressed and whether the menu button 15 is pressed for the predetermined period is determined.

In Step S328, whether the OK button 18 is pressed is determined. When the OK button 18 is pressed, the current folder is changed to a subfolder, which is in the current folder, and the processes that follows Step S340 will be carried out (detailed later). Further, in Step S329, whether the up-key 17U is pressed is determined. When the up-key 17U is pressed, whether the value of the variable “K” is equal to the maximum value “N” is determined in Step S334. When “K” is not equal to “N”, the value of the variable “K” is incremented by 1 in Step S335 and the process returns to Step S326. On the other hand, when K=N, in Step S336, the value of the variable “K” is reset to 1 and the process proceeds to Step S326. Namely, when the up-key 17U is pressed with the image of the folder “GUIDE_K” being displayed, and if there exists the folder having the number larger than the folder “GUIDE_K”, the current folder is changed to the folder “GUIDE_K+1” and the image of “title.bmp” of the new current folder is displayed. On the other hand, if the number of the current folder “GUIDE_K” is the maximum number “N”, the current folder is changed to the folder “GUIDE01” and the corresponding image will be displayed.

In Step S330, whether the down-key 17D is pressed is determined. When the down-key 17D is pressed, in Step S337, whether the value of the variable “K” is equal to 1 is determined. When “K” is not equal to 1, the value of the variable “K” is decremented by 1 in Step S338 and the process returns to Step S326. On the other hand, when K=1, the value of the variable “K” is reset to “N” in Step S339 and the process proceeds to Step S326. Namely, when the down-key 17D is pressed with the image of the “GUIDE_K” is displayed, and if there exists a folder having a number smaller than the folder “GUIDE_K”, the current folder is changed to the folder “GUIDE_K−1” and the image of “title.bmp” of the new current folder is displayed. On the other hand, if the number of the current folder “GUIDE_K” is the minimum number “1”, the current folder is changed to the folder “GUIDE_N” and the corresponding image will be displayed.

Further, in Step S331, whether the menu button 15 is pressed is determined. When the menu button 15 is pressed, the process returns to Step S303 so that the multi-image indication is resumed. Furthermore, in Step S332, whether the menu button 15 is depressed for the predetermined period is determined. When the menu button 15 is depressed for the predetermined period, this illustration-image indicating operation ends. Note that, the Steps S328 to S332 are repeated until one of the up-key 17U, the down-key 17D, the OK button 18, and the menu button 15 is pressed or the menu button 15 is pressed for the predetermined period.

Next, the processes that follow Step S340 will be explained. In the following explanation, the folder “GUIDE01”, which is the illustrated bird guide, is selected as an example. Namely, it corresponds the occasion when the OK button 18 is pressed when the current folder is at “GUIDE01” in Step S327 and the “title.bmp” of the illustrated bird guide is displayed on the image-indicating device 12. As shown in FIG. 12, the folder “GUIDE01” has four subfolders “SPRING”, “SUMMER”, “AUTUMN”, and “WINTER”. In Step S333, the current folder is changed to the first searched subfolder among the above-four folders. For example, when the search of the subfolders is carried out in the order listed in FIG. 3, the folder “SPRING” is searched first, so that the current folder is changed to the folder “SPRING” in Step S333. In Step S340, the image corresponding to the current folder or the current file (when the file is selected) is displayed on the image-indicating device 12. Since the current folder is “SPRING”, just after Step S333 has been carried out, the image of the “season1.bmp” which corresponds to the current folder is displayed on the image-indicating device 12.

In Steps S341 to S346, whether the cursor keys 17U, 17D, 17R, and 17L, the menu button 15, or the OK button 18 has been operated is determined. Namely, in Step S341, whether the up-key 17U has been pressed is determined and in Step S342, whether the down-key 17D has been pressed is determined. Further, in Step S343, whether the right-key 17R or the left-key 17L has been pressed is determined. Furthermore, whether the menu button 15 has been pressed and whether the OK button 18 has been pressed is determined in Steps S344 and S345, respectively, and in Step S346, whether the menu button 15 has been pressed for the predetermined period is determined.

When it is determined in Step S341 that the up-key 17U is pressed, the current folder is changed to the parent folder in Step S347. The process then returns to Step S340 and the image corresponding to the new current folder is displayed on the screen of the image-indicating device 12. For example, when the up-key 17U is pressed when the current folder is at “\GUIDE01\AUTUMN\TOWN” and when the corresponding image, such as the third image of the left column of FIG. 13, is displayed on the image-indicating device 12, the current folder is changed to “\GUIDE01\AUTUMN” and the second image of the left column of FIG. 13 is then displayed on the image-indicating device 12. However, when the parent is the root folder, the current folder will not be changed.

When it is determined, in Step S342, that the down-key 17D is pressed, subfolders of the current folder are searched and the current folder is changed to the first folder that was found in the above search. Further, if no subfolder is found, the first found illustration-image file is selected. Note that, it is preset to select a “*.jpg” file by default.

When a subfolder or a file is selected in Step S348, the image corresponding to the selected folder or file is displayed in Step S340. For example, if the down-key 17D is pressed when the current folder is at “\GUIDE01\AUTUMN\TOWN”, the subfolder “LARGE” is firstly found and the corresponding image, i.e. the file “size1.bmp”, is displayed on the image-indicating device 12. Further, if the down-key 17D is pressed when the current folder is at “\GUIDE01\AUTUMN\TOWN\SMALL”, the JPEG files “*.jpg” are searched, since the current folder has no subfolder. For example, when the file “thrush.jpg” is firstly found, the image shown in (a) of FIG. 5 is displayed on the image-indicating device 12.

When it is determined, in Step S343, that the right-key 17R or the left-key 17L is pressed, a previous or subsequent folder (or file) is searched in Step S349. For example, when the left-key 17L is pressed, the previous folder (or file) is searched and when the right-key 17R is pressed, the subsequent folder (or file) is searched. If the-right-key 17R is pressed when the current folder is at “\GUIDE01\AUTUMN\MOUNTAIN”, the current folder is changed to “\GUIDE01\AUTUMN\SEA”, for example. The process then returns to Step S340, such that the image that corresponds to the “\GUIDE01\AUTUMN\SEA” is displayed. Note that, the alteration of current folder due to the right-key 17R is carried out cyclically in the following order, “MOUNTAIN”→“SEA”→“TOWN”→“MOUNTAIN” and the alteration due to the left-key 17L is cyclically carried out in the opposite order. Further, the same is true with the file selection, so that the selection of a file is cyclically altered by operations of the right-key 17R and the left-key 17L and the image of the selected file is displayed on the image-indicating device 12.

When it is determined, in Step S344, that the menu button 15 is pressed, the type of the file that is adopted when selecting a file in Step S348 and Step S349 is altered in Step S350 and the process returns to Step S340. Namely, by default, a file with the extension “jpg” (file “*.jpg”) is subjected to the file selection. However, when the menu button 15 is pressed, the subject of the file selection is altered to a file with the extension “jpeg” (file “*.jpeg”). Further, when the menu button 15 is pressed while a “*.jpeg” file is being selected, the file selection is altered to the “*.jpg” files. For example, if the menu button 15 is pressed while the file “thrush.jpg” is being selected and the illustration-image, such as (a) of FIG. 5, is displayed, the file selection will be altered to the “thrush.jpeg”, so that the image shown at (b) of FIG. 5 will be displayed on the image-indicating device 12.

When it is determined that the OK button 18 is pressed, in Step S345, a voice file corresponding to the selected file is opened in Step S351, so that the song of the bird, which is displayed on the image-indicating device 12, is output from the speaker 30 (see FIG. 2) and the process returns to Step S340. For example, if the OK button 18 is pressed when the file “thrush.jpg” is selected, the song of the thrush, which is recorded in the “thrush.wav” is played. Note that, nothing will happen in this step when no file is selected.

When it is determined, in Step S346, that the menu button 15 is pressed for the predetermined period, this illustration-image indicating operation ends, and the process returns to the operations that are required to achieve functions of a normal digital camera. When none of the cursor keys 17U, 17D, 17R, and 17L, the menu button 15, or the OK button 18 is pressed, the process returns to Step S340 and the above-described processes are repeated.

As described above, according to the third embodiment of the present invention, an effect similar to the first and second embodiment can be obtained. Further, in the third embodiment, even when a plurality of illustrated-guide exists in a recording medium, the title images corresponding to the illustrated-guide can be displayed by the multi-image indication, so that the required illustrated-guide can be easily selected.

Further, the above-discussed file-binding systems, which are obtained by the file systems and the illustration-image indicating operations described in the above embodiments, can also be applied to the other optical apparatus, such as a digital camera, a digital telescope, and the like. Further, the file-binding system can be used apart from the optical apparatus when there is an object image required to be bound with illustrated-guide data, such as in the case when the object image is stored in a personal computer.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Applications Nos. 2003-312110, 2003-312130, and 2003-312176 (each filed on Sep. 4, 2003), which are expressly incorporated herein, by references, in their entirety.

1. An image-file managing system, comprising:
a recording medium that stores illustrated-guide data; and
a file-binding system that binds an object-image file of an observation target and said illustrated-guide data.

2. The image-file managing system according to claim 1, wherein said recording medium comprises a hierarchal folder system where the observation target is classified in categories based on predetermined attributes and where said categories are hierarchally combined as folders, and further illustration-image files of said illustrated-guide data, which comprise image data relating to the observation target, are allocated in the lowest subfolders, so that said file-binding system binds said object-image file and said illustrated-guide data by binding said object-image file and one of said illustration-image files.

3. The image-file managing system according to claim 2, wherein said object-image file has an area to store tag-information and said tag-information comprises a path of said illustration-image file in order to bind said object-image file and one of said illustration-image files.

4. The image-file managing system according to claim 2, further comprising:
an image-indicating device; and
at least one manually operated member that is used to select and designate a current folder along the structure of said hierarchal folder system.

5. The image-file managing system according to claim 4, wherein said recording medium stores folder-image files that comprise image data representing said categories which corresponds to each of said folders, and an image of a folder-image file corresponding to the current folder is displayed on said image-indicating device.

6. The image-file managing system according to claim 4, wherein an image of an illustration-image file is displayed on said image-indicating device, when the current folder is at said lowest subfolders.

7. The image-file managing system according to claim 6, wherein said illustration-image file is bound to said object-image file when a predetermined control button amongst said control buttons is operated while the image of said illustration-image file is displayed on said image-indicating device.

8. The image-file managing system according to claim 7, wherein the image of said object-image file is displayed on said image-indicating device when a predetermined control button amongst said control buttons is operated.

9. The image-file managing system according to claim 5, wherein an image of an illustration-image file is displayed on said image-indicating device due to an operation of a predetermined control button amongst said control buttons, when the current folder is at said lowest subfolder level.

10. The image-file managing system according to claim 5, wherein images of said illustration-image files are displayed on said image-indicating device as a multi-image indication, when the current folder is at said lowest subfolder level.

11. The image-file managing system according to claim 5, wherein said illustrated-guide data are separated into a plurality of illustrated guides and said image-file managing system comprises a counter that counts folders which correspond to said respective illustrated guides, so that the images of folder-image files corresponding to said illustrated guides are displayed as a multi-image indication, based on the number of said folders.

12. A digital camera, comprising:
an imaging device to capture an object-image of an observation object;
a recording medium that stores illustrated-guide data; and
a file-binding system that binds an object-image file storing said object-image and said illustrated-guide data.

13. An optical apparatus for observing an object, comprising:
an imaging device to capture an object-image of an observation object;
a recording medium that stores illustrated-guide data; and
a file-binding system that binds an object-image file storing said object-image and said illustrated-guide data.

14. An optical apparatus for observing an object, comprising:
an image-indicating device;
a recording medium that comprises a hierarchal folder system where the observation target is classified in categories based on predetermined attributes and where said categories are hierarchally combined as folders, and illustration-image files of illustrated-guide data, which comprise image data relating to the observation target, are allocated in the lowest subfolder level, and further, said recording medium has, folder-image files that comprise image data representing said respective folders; and
at least one manually operated member that is used to select and designate a current folder along the structure of said hierarchal folder system;
wherein an image of a folder-image file corresponding to the current folder is displayed on said image-indicating device, and images of said illustration-image files are displayed on said image-indicating device when the current folder is at said lowest subfolder level.

15. The optical apparatus according to claim 14, wherein said images of said illustration-image files are displayed on said image-indicating device as a multi-image indication when the current folder is at said lowest subfolder level.

16. The optical apparatus according to claim 14, wherein said illustrated-guide data comprises information relating to said illustration-image files.

17. The optical apparatus according to claim 16, further comprising an audio device that plays back voice data in a voice file, and said information relating to said illustration-image file comprises said voice data, so that said voice data is played back when said voice file is selected by using said control buttons.

18. The optical apparatus according to claim 14, wherein said at least one manually operated member is used to select said illustration-image files, so that an image of a selected illustration-image file is displayed.

19. The optical apparatus according to claim 14, wherein said categories comprise a category relating to the four seasons.

20. The optical apparatus according to claim 14, wherein said categories comprise a category relating to scenes where the observation is carried out.

21. The optical apparatus according to claim 14, wherein said categories comprise a category relating to the size of the observation target.

22. The optical apparatus according to claim 14, wherein the observation target comprises a bird or a flower.

23. The optical apparatus according to claim 22, wherein said information relating to said illustration-image file comprises voice data of a bird.

24. The optical apparatus according to claim 14, further comprises a recording medium connector that detachably connects to said recording medium.

25. The optical apparatus according to claim 14, further comprising
a digital camera that comprises an imaging device for capturing an image of the observation target and a recording/playback controller that records the image, which was captured by said imaging device, and displays the image on said image-indicating device;
wherein said recording/playback controller detects free storage space, which is separate from an area where said images and said information relating to the observation target are stored, so that the image captured by said imaging device is recorded into the free storage space.

26. The optical apparatus according to claim 25, further comprises a digital camera mode for operating said digital camera and an illustration-image indicating mode for indicating images of illustrated-guide data, and said digital camera mode and said illustration-image indicating mode are altered when said at least one manually operated member is pressed for a predetermined period.

27. The image-file managing system according to claim 14, wherein said illustrated-guide data are separated into a plurality of illustrated guides and said image-file managing system comprises a counter that counts the number of folders which correspond to said respective illustrated guides, so that the images of folder-image files corresponding to said illustrated guides are displayed as a multi-image indication, based on the number of said folders.
